(19) United States
(12) Patent Application Publication
(10) Pub. No.: US 2014/0333545 A1
(43) Pub. Date: Nov. 13, 2014

(54) PORTABLE DEVICE AND CONTROL METHOD THEREOF

(71) Applicant: LG ELECTRONICS INC., Seoul (KR)

(72) Inventors: Doyoung LEE, Seoul (KR); Yongsin KIM, Seoul (KR); Hyorim PARK, Seoul (KR)

(21) Appl. No.: 13/923,491

(22) Filed: Jun. 21, 2013

(30) Foreign Application Priority Data
May 9, 2013 (KR) 10-2013-0052549

(51) Int. Cl. G06F 3/041

(52) U.S. Cl. CPC G06F 3/0412
USPC 345/173

(57) ABSTRACT

A portable device and a method for controlling the same are discussed, in which a user may control a display of the device more conveniently and exactly. The portable device includes a main display unit; a flexible display unit; a touch sensor unit configured to sense a touch input of a user; a measurement unit configured to detect expanding of the flexible display; and a processor. The processor is further configured to: when a first image is displayed on a first area which is an expanded area of the flexible display unit, display a second image on a second area which is an additionally expanded area of the flexible display unit when additional expanding of the flexible display unit and a lack of a first touch input to the flexible display unit are sensed.

Pursuant to 35 U.S.C. §119(a), this application claims the benefit of the Korean Patent Application No. 10-2013-0052549, filed on May 9, 2013, which is hereby incorporated by reference as if fully set forth herein.

### BACKGROUND OF THE INVENTION

1. Field of the Invention

The present specification relates to a portable device with a flexible display, and more particularly, to a portable device and a control method thereof, in which a display of the device is controlled in accordance with an expansion signal of a flexible display and a touch input of a user.

2. Discussion of the Related Art

Mobility has been the important issue in the case that users use electronic devices. Particularly, various portable electronic devices having capabilities, which are equivalent to those of a desk top computer, as well as cellular phones have been selling recently. As sizes and weights of these portable electronic devices have been reduced, users could use various kinds of information even during movement.

These portable devices have performed various functions in addition to the existing basis function such as data transmission and reception. Accordingly, users should control the devices more conveniently and exactly. Particularly, with the spread of a flexible display panel, displays of portable devices could have been expanded. Accordingly, a control method for providing convenience of users in accordance with expanding and retracting of a display has been required. In more detail, a method for controlling a display of a display area additionally provided by expanding of a flexible display will be required.

### SUMMARY OF THE INVENTION

Accordingly, the present specification is directed to a portable device and a control method thereof, which substantially obviate one or more problems due to limitations and disadvantages of the related art.

An object of the present specification is to provide a portable device and a control method thereof, which is configured to control a display of a display area additionally expanded.

Another object of the present specification is to provide a portable device and a control method thereof, which is configured to control a display of a display area reduced by retracting of a flexible display.

Still another object of the present specification is to provide a portable device and a control method thereof, in which a display of the device is controlled in accordance with expanding of a flexible display and a touch input for the flexible display.

Further still another object of the present specification is to provide a portable device and a control method thereof, in which a display of the device is controlled in accordance with retracting of a flexible display and a touch input for the flexible display.

Further still another object of the present specification is to provide a portable device and a control method thereof, in which a display of the device is controlled in accordance with expanding of a flexible display and a multi-touch input for the flexible display.

Further still another object of the present specification is to provide a portable device and a control method thereof, in which a display of the device is controlled in accordance with retracting of a flexible display and a multi-touch input for the flexible display.

Further still another object of the present specification is to provide a portable device and a control method thereof, which provides an indicator indicating an enlarged or downsized area if an image is enlarged or downsized.

Additional advantages, objects, and features of the specification will be set forth in part in the description which follows and in part will become apparent to those having ordinary skill in the art upon examination of the following or may be learned from practice of the specification. The objectives and other advantages of the specification may be realized and attained by the structure particularly pointed out in the written description and claims hereof as well as the appended drawings.

To achieve these objects and other advantages and in accordance with the purpose of the specification, as embodied and broadly described herein, a portable device having a flexible display, the portable device comprises a main display unit; a flexible display unit; a touch sensor unit configured to sense a touch input of a user; a measurement unit configured to detect expanding of the flexible display; and a processor configured to control the main display unit, the flexible display unit, the touch sensor unit, and the measurement unit, wherein the processor is further configured to: when a first image is displayed on a first area which is an expanded area of the flexible display unit, display a second image on a second area which is an additionally expanded area of the flexible display unit when additional expanding of the flexible display unit and a lack of a first touch input to the flexible display unit are sensed, and display the first image on the first area and the second area by enlarging the first image when the additional expanding of the flexible display unit and the first touch input are sensed.

According to one embodiment, since zoom-in of a display of the enlarged area of the flexible display may be controlled by sensing of the touch input, the more intuitive and easier control method of the device may be provided.

Also, according to another embodiment, in the same manner as expanding of the flexible display, even in case of retracting, since zoom-out of a display may be controlled by sensing of the touch input, the more intuitive and easier control method of the device may be provided.

Also, according to another embodiment, since partial zoom-in or zoom-out may be controlled in accordance with a multi-touch input for the display, the display of the device may be controlled more effectively.

Also, according to another embodiment, since an indicator indicating an expanded area is provided, the user may control the display more conveniently and simply.

It is to be understood that both the foregoing general description and the following detailed description of the present specification are exemplary and explanatory and are intended to provide further explanation of the specification as claimed.

### BRIEF DESCRIPTION OF THE DRAWINGS

The accompanying drawings, which are included to provide a further understanding of the specification and are incorporated in and constitute a part of this application, illustrate embodiment(s) of the specification and together with the description serve to explain the principle of the specification. In the drawings:

FIG. 1 is a block diagram illustrating a portable device according to one embodiment;

FIGS. 2 and 3 are diagrams illustrating a device that controls a display in accordance with a user input as one embodiment;

FIG. 4 is a diagram illustrating a device if a touch input for a flexible display unit is released as one embodiment;

FIG. 5 is a diagram illustrating a device that controls a display in accordance with a user input as one embodiment; and

FIGS. 6 and 7 are flow charts illustrating a flow of a device that controls a display in accordance with a user input as one embodiment.

### DETAILED DESCRIPTION OF THE INVENTION

Reference will now be made in detail to the preferred embodiments of the present specification, examples of which are illustrated in the accompanying drawings. Wherever possible, the same reference numbers will be used throughout the drawings to refer to the same or like parts.

Although the terms used in the present specification are selected from generally known and used terms considering their functions in the present specification, the terms can be modified depending on intention of a person skilled in the art, practices, or the advent of new technology. Also, in special case, the terms mentioned in the description of the present specification may be selected by the applicant at his or her discretion, the detailed meanings of which are described in relevant parts of the description herein. Accordingly, the terms used herein should be understood not simply by the actual terms used but by the meaning lying within and the description disclosed herein.

Moreover, although the embodiments will be described in detail with reference to the accompanying drawings and the disclosure described by the drawings, it is to be understood that the present specification is not limited by such embodiments.

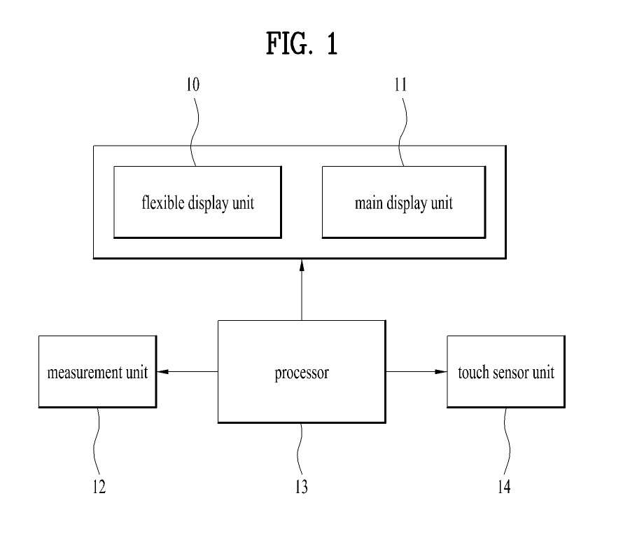

With the development of the manufacture technology of electronic devices, portable devices have been miniaturized. This specification relates to a mobile electronic device, which will be referred to as a portable device hereinafter. The portable device means various electronic devices having mobility. For example, the portable device includes electronic devices such as a cellular phone, a personal digital assistant (PDA), a notebook computer, a tablet PC, an MP3 player, a CD player, and a DVD player. Hereinafter, the portable device may be abbreviated as a device. Meanwhile, with the development of the technology of a display element built in the device, a flexible display unit has been commercialized. The flexible display unit refers to a display that is manufactured on a flexible substrate which may be bent, folded and rolled without loss of display properties, unlike the existing hard display panel. The flexible display unit may be referred to as an e-paper. The flexible display unit is characterized in that it is more lightweight, thinner, stronger impact resistance and bent more freely than the existing hard display. In case of the flexible display unit, the substrate may be made of a metal foil, very thin glass or plastic substrate. In particular, a PC substrate, PET substrate, PES substrate, PI substrate, PEN substrate, or AryLite substrate may be used as the plastic substrate. Meanwhile, in this specification, the flexible display unit is a higher concept of a flexible display, and refers to a display unit of which display area may be controlled by using at least one flexible display panel or a plurality of separated display panels. The flexible display unit may be built in the device in various manners. The built-in method of the flexible display unit will be described in detail with reference to FIG. 1.

FIG. 1 is a block diagram illustrating a device according to one embodiment. In FIG. 1, the device may include a flexible display unit 10, a main display unit 11, a measurement unit 12, a touch sensor unit 14, and a processor 13.

The flexible display unit 10 and the main display unit 11 may output image data on a display screen. In particular, in this specification, the flexible display unit 10 may gradually display images to correspond to expanding of a length or area according to flexible properties. Also, the main display unit 11 and the flexible display unit 10 may output an image on the basis of contents implemented by the processor 13 or a control command of the processor 13. Also, the flexible display unit 10 and the main display unit 11 may output a display page of contents implemented by the processor 13. In this specification, the image may represent still images, moving pictures, and texts, which may be displayed in the main display unit 11 and the flexible display unit 10, or other various images, which may be expressed visually.

Also, according to one embodiment, the flexible display unit 10 and the main display unit 11 may display an enlarged or downsized image in accordance with a user input. In this specification, the enlarged image may represent an image enlarged by a pre-set enlargement magnification or in an enlarged direction. Also, the downsized image may represent an image downsized by a pre-set downsizing magnification or in a downsizing direction. Also, according to another embodiment, the flexible display unit 10 and the main display unit 11 may display zooming image in accordance with a user input. In this specification, zooming may mean that a part of displayed information is subjected to zoom in or zoom out. In other words, zooming may represent enlargement or downsizing of a specific area of image. Accordingly, in this specification, zoom-in may be identified from enlargement and zoom-out may be identified from downsizing depending on whether all or some of the image is enlarged or downsized.

The flexible display unit 10 and the main display unit 11 may be provided in the device in various form. According to one embodiment, the flexible display unit 10 and the main display unit 11 may be configured as one flexible display panel. For example, the flexible display panel part always exposed towards the outside of the device may be referred to as the main display unit 11, and the flexible display panel part that may be expanded additionally if necessary may be referred to as the flexible display unit 10. According to another embodiment, the flexible display unit 10 and the main display unit 11 may be configured by combination of at least one hard display and at least one flexible display. For example, the main display unit 11 may be configured by a hard display panel, and the flexible display unit 10 may be configured by a flexible display panel. At this time, the user may use additional display space by expanding the flexible display unit 10 if necessary. In other words, the flexible display unit 10 and the main display unit 11 may be provided in the device in various forms in accordance with design and usage of the device without limitation to the aforementioned embodiments.

Also, the flexible display unit 10 may be built in the device in various manners. In more detail, the flexible display unit 10 may be built in the device in a manner of slide-in, rolling or bending. The user may use additional display space if necessary by expanding the flexible display unit built in the device in various manners.

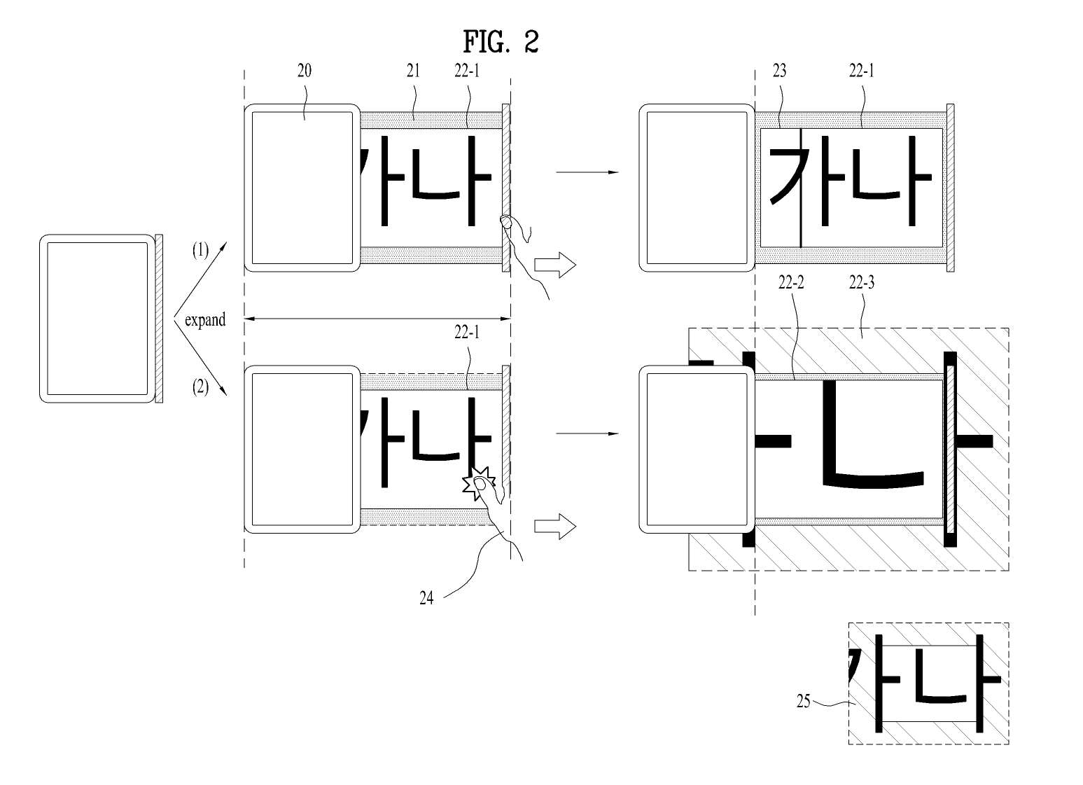

The flexible display unit 10 may be expanded in various manners. According to one embodiment, the flexible display unit 10 may be expanded automatically or manually. If the flexible display unit 10 is expanded manually, a hardware type grip potion may be provided at one side of the flexible display unit to facilitate expanding of the flexible display unit 10. Alternatively, a software type grip portion or hinge portion may be provided to prevent error operation of the device from occurring and facilitate expanding of flexible display unit 10. The processor 13 may bypass sensing of a touch input of the user for a specific area of the flexible display unit 10, whereby the specific area may serve as the grip portion. The user may expand the flexible display unit 10 by pulling the grip portion in a direction that the flexible display unit 10 is expanded. In this case, the touch input of the user for the flexible display unit 10 may not be sensed. This specification relates to a method how to control a display of the flexible display unit area expanded in various manners, wherein the display is controlled based on sensing of the touch input of the user. The control of the display will be described later in more detail with reference to FIG. 2.

Hereinafter, for convenience of description, the flexible display unit 10 and the main display unit 11 will be referred to as a display unit or display.

The measurement unit 12 may sense various user inputs for expanding of the flexible display unit 10 and then forward the sensed result to the processor 13. In particular, according to one embodiment, the measurement unit 12 may measure at least one of expanding or not of the flexible display unit 10, an expanded length and an expanded area and forward the measured result to the processor 13.

In more detail, the measurement unit 12 may include a measurement sensor that measures the expanded length or area of the flexible display unit 10. The measurement unit 12 may measure the area or length of the flexible display unit 10 exposed to the outside of the device if the flexible display unit 10 is expanded or retracted. On the other hand, the measurement unit 12 may measure the area or length of the flexible display unit 10 inside the device, which is not expanded. The measurement unit 12 may include, but not limited to, various sensing means such as a proximity sensor, a touch sensor and an infrared sensor to sense an expanded level of the flexible display unit 10.

The touch sensor unit 14 may forward a user input or an environment recognized by the device to the processor 13 by using at least one sensor provided in the device. In more detail, the touch sensor unit 14 may sense a touch input of the user for the display unit by using at least one sensor provided in the device. At this time, the device may include the touch sensor unit 14 in the display unit. The touch sensor unit 14 may include at least one sensing means. According to one embodiment, the at least one sensing means may include various touch sensing means such as a touch sensor, a fingerprint sensor, a motion sensor, a proximity sensor and a pressure sensor. The touch sensor unit 14 refers to the aforementioned various sensing means, and the aforementioned sensors may be included in the device as separate elements or may be incorporated into at least one element. Meanwhile, the touch sensor unit 14 may sense various touch inputs of contact or non-contact such as a long-press touch input, a short-press touch input, a drag touch input, a release touch input, a hovering input and a flicking touch input. Moreover, the touch sensor unit 14 may sense a touch input based on various touch input tools such as a touch pen and stylus pen and forward the sensed result to the processor 13.

The processor 13 may implement various applications by processing data inside the device. Also, the processor 13 may control contents of the device on the basis of a contents control command. Also, the processor 13 may control each unit of the device, and may control data transmission and reception between the units. Also, if a user input is sensed through the touch sensor unit 14, the processor 13 may implement a command based on the user input. Particularly, in this specification, the processor 13 may control an image displayed on the display unit in accordance with the sensed result of the user input. In more detail, if the touch input for the display unit and an expanding signal of the flexible display unit 10 are sensed, the processor 13 may control the display unit so that the enlarged or downsized image is displayed.

Hereinafter, if each step or operation performed by the portable device starts or is performed by the user input, it is understood that the procedure of generating an input signal in accordance with the user input includes description of the above procedure even without repeated description. Also, it may be expressed that the processor 13 controls the device or at least one unit included in the device in accordance with the user input, and it may be described that the processor 13 may mean the device.

In the meantime, FIG. 1 is a block diagram illustrating a portable device according to one embodiment. In FIG. 1, respective blocks are shown to logically identify the elements of the device. Accordingly, the aforementioned elements of the device may be provided as one chip or a plurality of chips in accordance with design of the device.

FIG. 2 is a diagram illustrating a device that controls displaying in accordance with a user input as one embodiment. In more detail, if the flexible display unit 21 is expanded, the device controls displaying in accordance with sensing or not of a touch input 24 of the user for the flexible display unit 21.

First of all, if a lack of the touch input 24 of the user for the flexible display unit 21 is sensed, the device may additionally display an image to correspond to expanding of the flexible display unit 21. In more detail, when a first image 22-1 is displayed on the expanded flexible display unit 21, if the flexible display unit 21 is additionally expanded, the device may display a second image 23 on the additional expanded area of the flexible display unit 21. At this time, the second image 23 and the first image 22-1 may be different parts of one image. In other words, as shown in FIG. 2-(1), as the flexible display unit 21 is expanded, the device may display one image by gradually displaying the image from a part to the entire part. However, although the direction that the image is displayed by expanding of the flexible display unit 21 is the left side in FIG. 2-(1), it may be various directions such as the upper side, the lower side, the right side and the diagonal line in accordance with the embodiment without limitation to the shown drawing. In particular, the direction that the image is displayed may be changed in accordance with design and usage of the device and types of an application which is being implemented. A lack of sensing of the touch input 24 of the user for the flexible display unit 21 may be various embodiments such as a case where the flexible display unit 21 is automatically expanded, and a case where the user grips the grip portion and expand the flexible display unit 21.

In the meantime, as described above, although the first image 22-1 and the second image 23 may be different image areas of one image, the first image 22-1 and the second image 23 may be a plurality of images in accordance with the embodiment (not shown). For example, the first image 22-1 may be an implementation screen of a first application, and the second image 23 may be an implementation screen of a second application. Moreover, the second image 23 may be the image related to the first image 22-1. For example, if the first image 22-1 is a photo, the second image 23 may be the image representing additional information of the photo which is the first image 22-1.

Hereinafter, for convenience of description, the image which is being displayed on the expanded flexible display unit 21 will be referred to as the first image 22-1. Also, the device that additionally displays one image to correspond to expanding of the flexible display unit 21 will be described. Namely, the direction that an image is additionally displayed by expanding of the flexible display unit 21 is the left side will be described.

Next, in case of expanding of the flexible display unit 21, if the touch input 24 of the user for the flexible display unit is sensed, the device may display an image by enlarging the image to correspond to expanding of the flexible display unit 21 (22-2). In other words, if the expanding signal of the flexible display unit 21 and the touch input signal 24 of the user for the flexible display unit 21 are sensed at the same time, the device may enlarge an image, which is being currently displayed. The touch input 24 for the flexible display unit 21 may be sensed when the user touches a touch sensing area of the flexible display unit 21, as shown in FIG. 2-(2).

In more detail, if the first image 22-1 is being displayed in the expanded area of the flexible display unit 21, as the touch input of the user and additional expanding of the flexible display unit 21 are sensed together, the device may display enlarged first image on the expanded area and the additionally expanded area of the flexible display unit 21(22-2). In other words, if the touch input 24 of the user and additional expanding of the flexible display unit 21 are sensed at the same time, the device may display the first image, which is being currently displayed, by enlarging the first image (22-2). For example, as shown in FIG. 2-(2), if “ [symbol] ” is being displayed on the expanded area of the flexible display unit 21 (22-1) and at this time the touch input 24 of the user and additional expanding of the flexible display unit 21 are sensed together, the device may display enlarged “ [symbol] ” on the expanded area and the additionally expanded area of the flexible display unit 21(22-2).

Namely, in case of additional expanding of the flexible display unit 21, the device may display additional image of the first image or the enlarged first image depending on sensing of the touch input of the user.

Moreover, as one embodiment, a lack of the touch input 24 of the user and additional expanding of the flexible display unit 21 may be sensed while the enlarged first image is being displayed (22-2). At this time, the device may return to the case of FIG. 2-(1) and display the second image 23, which is the additional image of the enlarged first image 22-2 currently displayed, on the additionally expanded area of the flexible display unit 21. At this time, the first image 22-2 and the second image 23 may represent different image areas of the enlarged one image. Also, the second image 23 may be the image connected from the first image 22-2. In this case, since the second image 23 is the image added to the enlarged first image 22-2, the second image 23 in this embodiment may be the image enlarged at an enlargement magnification of the first image 22-2 unlike the second image 23 in FIG. 2-(1).

In the meantime, the first image 22-2 may be enlarged in various manners. As one embodiment, although the image is enlarged in all directions in the drawing, the image may be enlarged in various directions such as up and down direction, a left and right direction, and a diagonal direction. Also, the first image 22-2 may be displayed by being enlarged at various magnifications, and the device may provide various enlargement magnifications in accordance with setting of the user or design of the device. Also, the device may display the first image 22-2 by enlarging the first image 22-2 corresponding to the expanding of the flexible display unit 21. For example, as the expanded length or expanded area of the flexible display unit 21 is increased, the device may enlarge gradually the first image 22-2 according to the expanding of the flexible display unit 21. Accordingly, some area 22-3 of the first image may not be displayed in the flexible display unit 21 in accordance with the enlargement magnification and enlargement direction of the first image.

Also, as one embodiment, if the first image 22-2 is enlarged and then is being displayed (22-2), the device may display an indicator 25 indicating the enlarged area of the first image 22-1. If the first image 22-1 is enlarged at a certain magnification and then displayed (22-2), the user may feel confusion as to what area of the first image 22-1 is enlarged. In order to avoid such confusion, the device may display the indicator 25, which indicates the enlarged area of the first image 22-2, in the main display unit 20 and/or the flexible display unit 21. The indicator 25 may be displayed in the display unit as a graphic user interface, and may indicate the enlarged area to the user in various manners. Also, the device may display the enlargement magnification of the first image as additional information.

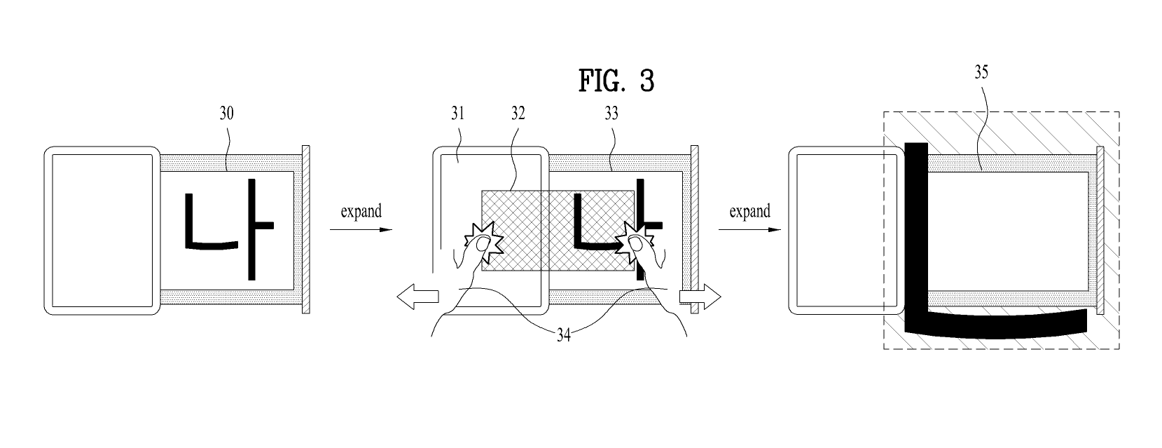

In the meantime, the device of which display is controlled in accordance with sensing or not of the touch input 24 for the flexible display unit 21 has been described in this embodiment. However, the display may be controlled in accordance with touch input sensing for the main display unit 20 as the case may be. For example, if additional expanding of the flexible display unit 21 and the touch input for the main display unit 20 are sensed at the same time, the device may display the enlarged first image 22-2 on the expanded area and additionally expanded area of the flexible display unit 21. In this case, the image may be enlarged to the maximum range unlike that the display is controlled by the touch input for the flexible display unit 21. Since the flexible display unit 21 is rolled in inside the device, the touch input for the flexible display unit 21 may be difficult before the flexible display unit 21 is expanded. However, since the main display unit 20 is always exposed to the outside of the device, the touch input for enlarging the image may be performed from the time when the flexible display unit 21 is first expanded. Accordingly, when it is intended to enlarge the image to the maximum range, as one embodiment, the touch input for the main display unit 20 may be selected as a control means for enlargement of the image. Moreover, enlargement of the image may be controlled even by the multi-touch input for the flexible display unit 21 and the main display unit 20. Moreover, as another embodiment, zooming of the display may be controlled by the multi-touch input. Zooming control of the display will be described later with reference to FIG. 3. Hereinafter, the device of which display is controlled by the touch input for the flexible display unit 21 will be described.

FIG. 3 is a diagram illustrating a device that controls a display in accordance with a user input as one embodiment. In more detail, when the flexible display unit 33 is expanded, if the multi-touch input 34 for the flexible display unit 33 and the main display unit 31 is sensed, the device provides a zooming function in accordance with the sensed touch input 34.

As described with reference to FIG. 2, if the flexible display unit 33 is expanded, the device may control displaying in accordance with the touch input 34 for at least one of the flexible display unit 31 and the main display unit 31. However, at this time, enlargement of the image represents full enlargement of the first image, and is identified from the zooming function 35 in this embodiment as described with reference to FIG. 1.

In more detail, as the flexible display unit 33 is expanded, if multi-touch input 34 for the main display unit 31 and the flexible display unit 33 is sensed, the device may provide the zooming function 35.

The image area 32 that is subjected to zooming may be determined on the basis of the point of the multi-touch input 34. In more detail, the device may perform zooming for the image area 32 between the points of the multi-touch input 34 by designating the corresponding image area 32 as a partially enlarged area or partially downsized area. For example, as shown in FIG. 3, a rectangular area 32 having the distance between the multi-touch inputs 34 as a width may be designated as the zooming area. Alternatively, for another example, although not shown, a circle area having the distance between the multi-touch inputs 34 as a diameter may be designated as the zooming area. In other words, the zooming area 32 may be designated in various forms on the basis of the sensing point of the multi-touch input 34 without limitation to the aforementioned embodiment. At this time, if the main display unit 31 and the flexible display unit 33 are mutually connected with each other, the device may perform zooming for the image area 32 between the touch input sensing point of the main display unit 31 and the touch input sensing point of the flexible display unit 33. However, if the main display unit 31 and the flexible display unit 33 are disconnected from each other, the device may perform zooming for the image area 32 between the touch input sensing point of the flexible display unit 33 and the boundary line between the device and the flexible display unit.

Zooming is a higher concept than zoom in and zoom out, and zoom in or zoom out may be performed in accordance with expanding or retracting of the flexible display unit. In more detail, if the multi-touch input 34 for the display units 31 and 33 and expanding of the flexible display unit 33 are sensed, the device may perform zoom-in for the image. For example, as the expanded length or expanded area of the flexible display unit 33 is increased, the device may display the image by gradually performing zoom-in for the image (35). On the other hand, if the multi-touch input 34 for the display units 31 and 33 and retracting of the flexible display unit 33 are sensed, the device may perform zoom-out for the image. For example, the device may display the image by gradually performing zoom-out for the image as the retracting length or retracting area of the flexible display unit 33 is increased.

Zooming 35 of the image may be performed in various manners in the same manner as that the first image is enlarged in FIG. 2. For example, the device may perform zooming 35 for the image in various directions such as an all direction, an up and down direction, a left and right direction, and a diagonal direction. Also, the device may perform zooming 35 for the image at various enlarging or downsizing magnifications.

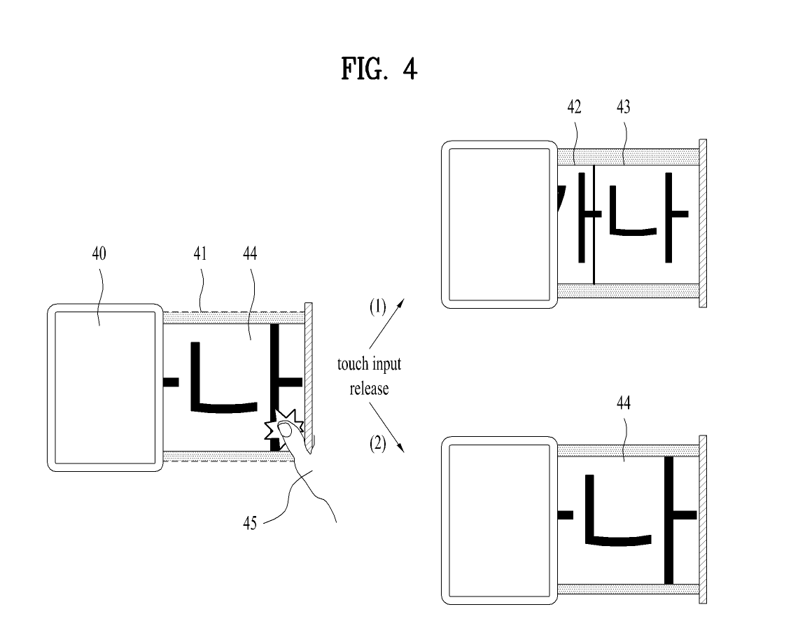

FIG. 4 is a diagram illustrating a device if a touch input 45 for a flexible display unit 41 is released as one embodiment. In more detail, FIG. 4 illustrates a control method of displaying if the touch input 45 is released while a first image 43 is displayed (44) by being enlarged by the touch input for the flexible display unit 41.

As one embodiment, if release of the touch input 45 is sensed while the first image 43 is displayed by being enlarged (44), the device may switch the enlarged first image 44 to the first image 43 before expanding and then display the image 44 in the flexible display unit 41. Moreover, the device may display the second image 42 which is additional image for the first image 43 in the additionally expanded area of the flexible display unit 41. In other words, as shown in FIG. 4-(1), if release of the touch input 45 is sensed, the first image 43 and the second image 42 corresponding to an expanded length of the flexible display unit 41 may be displayed.

As another embodiment, if release of the touch input 45 is sensed while the first image 43 is displayed by being enlarged (44), the device may display the enlarged first image 44 as it is. In other words, if release of the touch input 45 is sensed while the first image 43 is displayed by being enlarged (44), the device may not perform any separate operation. Accordingly, in this case, there may be inconvenience in that the user should retract the flexible display unit 41 and then expand the flexible display unit 41 in order to view the first image 43 which is not enlarged and the second image 42 which is additional image of the first image, unlike the aforementioned embodiment. Accordingly, the user may set the operation of the device based on release of the touch input 45 in various manners if necessary. Alternatively, the user may set the proper operation of the device based on release of the touch input 45 in various manners in accordance with types of the application which is being currently implemented.

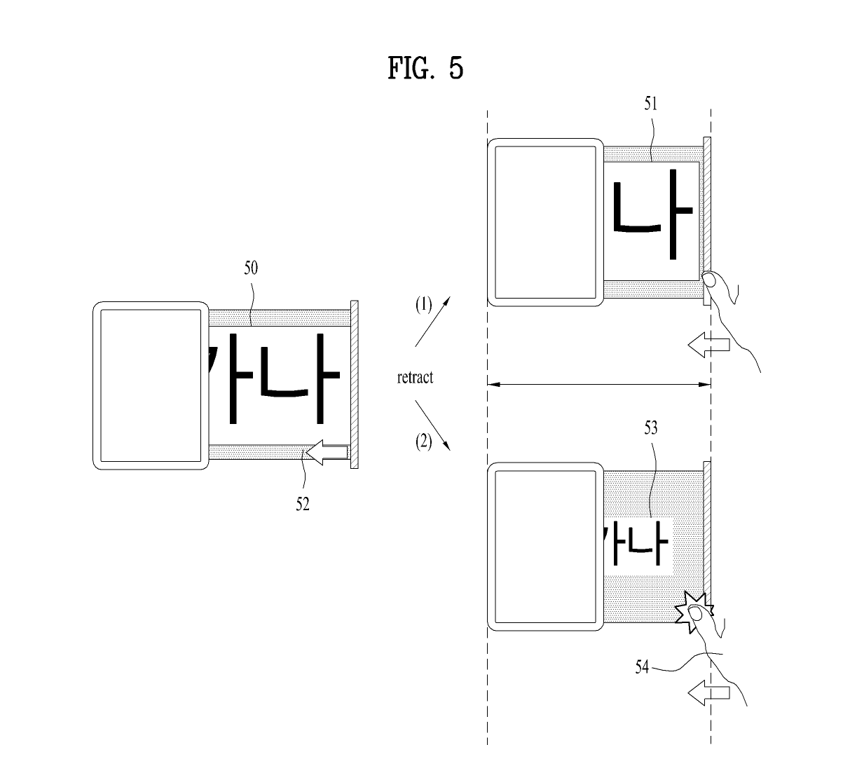

FIG. 5 is a diagram illustrating a device that controls displaying in accordance with a user input as one embodiment. In more detail, FIG. 5 illustrates a device that controls displaying in accordance with sensing or not of a touch input 54 of a user for a flexible display unit 52 if the flexible display unit 52 is retracted. The operation of the device when retracting of the flexible display unit 52 and the touch input 54 are sensed corresponds to that of the device when expanding of the flexible display unit and the touch input are sensed as described with reference to FIG. 2.

First of all, if a lack of the touch input 54 of the user for the flexible display unit 52 is sensed, the device may downsize the image area to correspond to retracting of the flexible display unit 52.

In more detail, the device may display the first image 50 in the expanded flexible display unit 52. At this time, if the flexible display unit 52 is retracted, the device may display the second image 51 in the expanded area of the retracted flexible display unit 52. At this time, the second image 51 may be the image included in the first image 50. In other words, as described with reference to FIG. 2-(1), the first image 50 and the second image 51 may be parts of one image. In other words, as the flexible display unit 52 is retracted, the device may gradually downsize one image 50 from all to a part and then display the downsized image. However, although the direction that the display area of the image 50 is retracted by retracting of the flexible display unit 52 is the right side in FIG. 5-(1), it may be various directions such as the upper side, the lower side, the right side and the diagonal line in accordance with the embodiment without limitation to the shown drawing. In particular, the direction that the display area of the image 50 is retracted may be changed in accordance with design and usage of the device and types of an application which is being implemented.

Next, when the flexible display unit 52 is retracted, if the touch input 54 of the user for the flexible display unit 52 is sensed, the device may downsize the image 50 to correspond to retracting of the flexible display unit 52 and then display the downsized image. In other words, if a retracting signal of the flexible display unit 52 and a touch input signal 54 for the flexible display unit 52 are sensed at the same time, the device may display the image 50 which is being currently displayed, through downsizing. For example, as shown in FIG. 5-(2), if “ [symbol] ” 50 is being displayed on the expanded area of the flexible display unit 52 and the touch input 54 of the user and retracting of the flexible display unit 52 are sensed at the same time, the device may display “ [symbol] ” 50 on the expanded area of the retracted flexible display unit 52 through downsizing (53).

Moreover, as one embodiment, a lack of the touch input 54 of the user and additional retracting of the flexible display unit 52 may be sensed while the first image 50 is being displayed by being downsized (53). At this time, the device may return to the case of FIG, 5-(1) and display the second image, which is the partial image of the downsized first image 53 currently displayed, in the flexible display unit 52.

In the meantime, the first image 53 may be downsized in various manners in the same manner as the enlargement manner in FIG. 2. As one embodiment, the first image 50 may be downsized in various directions such as an up and down direction, a left and right direction, and a diagonal direction. Also, the first image 50 may be displayed by being downsized at various magnifications, and the device may provide various downsizing magnifications in accordance with setting of the user or design of the device. Also, the device may display the first image 50 by downsizing (53) the first image 50 in accordance with retracting of the flexible display unit 52. For example, as the retracting length or retracting area of the flexible display unit 52 is increased, the device may display the first image 50 by gradually downsizing the first image 50.

Also, although not shown, as one embodiment, if the first image 50 is downsized and then is being displayed (53), the device may display an indicator indicating the downsized area of the first image 50. The indicator may be displayed as a graphic user interface, and may indicate the downsized area to the user in various manners. Also, the device may display the downsizing magnification of the first image 50 as additional information.

Also, although not shown, similarly to the embodiment of FIG. 4, if release of the touch input 54 is sensed while the first image 50 is displayed by being downsized (53), the device may display the second image 51 which a part of the first image 50 before downsizing, in the flexible display unit 52. In other words, if release of the touch input 54 is sensed, the device may return to the case of FIG. 5-(1) and display some image area corresponding to the expanded length. As another embodiment, if release of the touch input 54 is sensed while the first image 50 is displayed by being downsized, the device may display the downsized first image 53 as it is. However, the operation of the device based on release of the touch input 54 may be set in various manners in accordance with usage of the device, design of the device, and types of the application which is being currently implemented, as described with reference to FIG. 4.

In the meantime, the device of which display is controlled in accordance with sensing or not of the touch input 54 for the flexible display unit 52 has been described in this embodiment. However, similarly to the description of FIG. 2, the display may be controlled in accordance with touch input sensing for the main display unit as the case may be. Also, the display may be controlled even by a multi-touch input for the flexible display unit 52 and the main display unit. In particular, if the multi-touch input is sensed, the device may provide a zooming function of which detailed description corresponds to the description of FIG. 3.

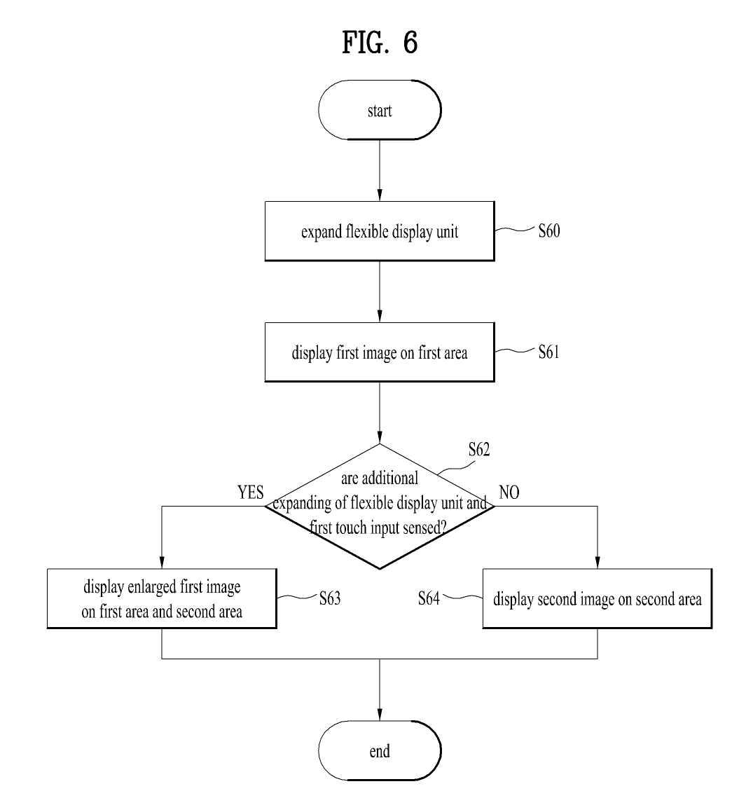

FIG. 6 is a flow chart illustrating a flow of a device that controls displaying in accordance with a user input as one embodiment. Hereinafter, each step of FIG. 6, which will be described later, may be controlled by the processor 13 shown in FIG. 1. Also, in the embodiment of FIG. 6, detailed description of the same or like parts as those of the embodiments of FIG. 1 to FIG. 4 will be omitted.

First of all, the flexible display unit may be expanded (S60).

A first image may be displayed in the expanded flexible display unit (S61). At this time, the expanded area of the flexible display unit may be referred to as a first area.

Next, the device may determine whether additional expanding of the flexible display unit and a first touch input for the flexible display unit have been sensed (S62). In more detail, the device may determine whether additional expanding of the flexible display unit and the first touch input for the flexible display unit have been sensed together or not.

If additional expanding of the flexible display unit and the first touch input for the flexible display unit are sensed at the same time, the device may display enlarged first image in the first area and a second area which is additionally expanded area of the flexible display unit (S63). The more detailed description of the method for enlarging the first image is as described with reference to FIG. 2.

If at least one of additional expanding of the flexible display unit and the first touch input for the flexible display unit is not sensed, the device may additionally display the second image in the second area (S64). In accordance with one embodiment, the second image may be additional image of the first image. Alternatively, in accordance with another embodiment, the second image may be the image separately from the first image or the image indicating information related to the first image. The more detailed description of the method for enlarging the first image is as described with reference to FIG. 2.

In the meantime, as additional expanding of the flexible display unit and the first touch input for the flexible display unit are sensed at the same time, if release of the touch input is sensed while the first image is displayed by being enlarged, the device may control displaying of the flexible display unit. As one embodiment, the device may switch the enlarged first image to the first image before enlargement and then display the switched image in the flexible display unit. Moreover, the device may display the second image which is additional image for the first image in the additionally expanded area of the flexible display unit. As another embodiment, if release of the touch input is sensed, the device may maintain the display state of the flexible display unit as it is. In other words, even though release of the touch input is sensed, the device maintains the current display state but may not perform any separate operation. The detailed description of this status is as described with reference to FIG. 4.

Moreover, if the first image is displayed in the flexible display unit by being enlarged, the device may display the indicator indicating the enlarged area of the first image. This is as described with reference to FIG. 2.

Also, although the touch input for the flexible display unit has been described as one embodiment in this flow chart, the touch input for the main display unit may be selected as a control reference of the display as described with reference to FIG. 2. Moreover, if the multi-touch input of the flexible display unit and the main display unit is sensed, the device may provide a zooming function as described with reference to FIG. 3.

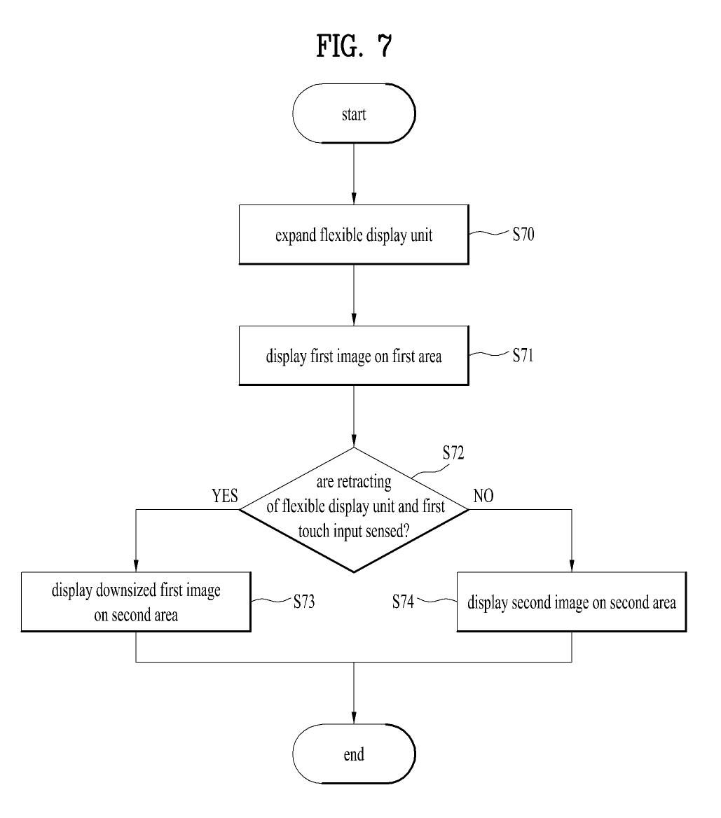

FIG. 7 is a flow chart illustrating a flow of a device that controls displaying in accordance with a user input as one embodiment. Hereinafter, each step of FIG. 7, which will be described later, may be controlled by the processor 13 shown in FIG. 1. Also, in the embodiment of FIG. 7, detailed description of the same or like parts as those of the embodiment of FIG. 5 will be omitted.

First of all, the flexible display unit may be expanded (S70).

A first image may be displayed in the expanded flexible display unit (S71). At this time, the expanded area of the flexible display unit may be referred to as a first area.

Next, the device may determine whether retracting of the flexible display unit and a first touch input for the flexible display unit have been sensed or not (S72).

If retracting of the flexible display unit and the first touch input for the flexible display unit are sensed, the device may display a downsized first image in the second area which is the expanded area of the retracted flexible display unit (S73). In more detail, the device may determine whether retracting of the flexible display unit and the first touch input for the flexible display unit have been sensed together or not. At this time, the second area may be a part of the first area. In other words, the second area may be the area included in the first area. The more detailed description of the method for downsizing the first image is as described with reference to FIG. 5.

If at least one of retracting of the flexible display unit and the first touch input for the flexible display unit is not sensed, the device may display the second image in the second area (S74). In this case, the second image may be a part of the first image.

In the meantime, as retracting of the flexible display unit and the first touch input for the flexible display unit are sensed at the same time, if release of the touch input is sensed while the first image is displayed by being downsized, the device may control the displaying of the flexible display unit. As one embodiment, the device may display the second image, which is a part of the first image before downsizing, in the retracted flexible display unit. As another embodiment, if release of the touch input is sensed, the device may maintain the display state of the flexible display unit as it is. In other words, even though release of the touch input is sensed, the device maintains the current display state but may not perform any separate operation. The detailed description of this status is as described with reference to FIG. 4 and FIG. 5.

Moreover, if the first image is displayed in the flexible display unit by being downsized, the device may display the indicator indicating the downsized area of the first image. This is as described with reference to FIG. 5.

Also, although the touch input for the flexible display unit has been described as one embodiment in this flow chart, the touch input for the main display unit may be selected as a control reference of the display as described with reference to FIG. 5. Moreover, if the multi-touch input of the flexible display unit and the main display unit is sensed, the device may provide a zooming function as described with reference to FIG. 3.

Although the description may be made for each of the drawings for convenience of description, the embodiments of the respective drawings may be incorporated to achieve a new embodiment. A computer readable recording medium where a program for implementing the embodiments is recorded may be designed in accordance with the need of the person skilled in the art within the scope of the present specification.

Also, the device and the control method thereof are not limited to the aforementioned embodiments, and all or some of the aforementioned embodiments may selectively be configured in combination so that various modifications may be made in the aforementioned embodiments.

It will be apparent to those skilled in the art that the present specification can be embodied in other specific forms without departing from the spirit and essential characteristics of the specification. Thus, the above embodiments are to be considered in all respects as illustrative and not restrictive. The scope of the specification should be determined by reasonable interpretation of the appended claims and all change which comes within the equivalent scope of the specification are included in the scope of the specification.

Also, in this specification, it is to be understood that a width, an area and a length may mean exact values and include a substantial width, area and length of a certain range. In other words, in this specification, an expanding level of the flexible display unit may mean a substantial expanding level and may have an error of a certain range.

Also, in this specification, both the product invention and the method invention have been described, and description of both inventions may be made complementally if necessary.

What is claimed is:

1. A portable device having a flexible display, the portable device comprising:
a main display unit;
a flexible display unit;
a touch sensor unit configured to sense a touch input of a user;
a measurement unit configured to detect expanding of the flexible display; and
a processor configured to control the main display unit, the flexible display unit, the touch sensor unit, and the measurement unit,
wherein the processor is further configured to:
when a first image is displayed on a first area which is an expanded area of the flexible display unit,
display a second image on a second area which is an additionally expanded area of the flexible display unit when additional expanding of the flexible display unit and a lack of a first touch input to the flexible display unit are sensed, and
display the first image on the first area and the second area by enlarging the first image when the additional expanding of the flexible display unit and the first touch input are sensed.

2. The portable device according to claim 1, wherein the processor is further configured to display the first image on the first area and the second area by gradually enlarging the first image according to the additional expanding of the flexible display unit.

3. The portable device according to claim 1, wherein the measurement unit is further configured to measure an expanded length of the flexible display unit.

4. The portable device according to claim 1, wherein the second image is the image connected from the first image.

5. The portable device according to claim 1, wherein the processor is further configured to display the first image on the first area and the second area by enlarging the first image in all directions.

6. The portable device according to claim 1, wherein the processor is further configured to display the first image by partially enlarging the first image on a basis of a point where the first touch input is sensed when the additional expanding of the flexible display unit, the first touch input, and a second touch input to the main display unit are sensed at the same time.

7. The portable device according to claim 1, wherein the processor is further configured to switch the enlarged first image displayed on the first area and the second area to the first image on the first area and to the second image on the second area, when release of the sensed first touch input is sensed.

8. The portable device according to claim 1, further comprising a grip portion provided at one side of the flexible display unit.

9. The portable device according to claim 1, wherein the processor is further configured to display a graphic user interface indicating a displayed area of the enlarged first image in the flexible display unit or the main display unit when the enlarged first image is displayed on the first area and the second area.

10. A portable device having a flexible display, the portable device comprising:
a main display unit;
a flexible display unit;
a touch sensor unit configured to sense a touch input of a user;
a measurement unit configured to measure an expanded length of the flexible display unit; and
a processor configured to control the main display unit, the flexible display unit, the touch sensor unit, and the measurement unit,
wherein the processor is further configured to:
when a first image is displayed on a first area which is an expanded area of the flexible display unit,
display a second image on a second area which is an expanded area of a retracted flexible display unit when retracting of the flexible display unit and a lack of a first touch input to the flexible display unit are sensed, and
display the first image on the second area by downsizing the first image when the retracting of the flexible display unit and the first touch input are sensed.

11. The portable device according to claim 10, wherein the processor is further configured to display the first image on the second area by gradually downsizing the first image according to the retracting of the flexible display unit.

12. The portable device according to claim 10, wherein the first image is the image that includes the second image.

13. The portable device according to claim 10, wherein the processor is further configured to display the first image by partially downsizing the first image on a basis of a point where the first touch input is sensed when the retracting of the flexible display unit, the first touch input, and a second touch input to the main display unit are sensed at the same time.

14. The portable device according to claim 10, wherein the processor is further configured to display the first image on the second area by downsizing the first image in all directions.

15. A control method of a portable device having a flexible display, the method comprising the steps of:
expanding a flexible display unit;
displaying a first image on a first area which is an expanded area of the flexible display unit; and
displaying a second image on a second area which is an additionally expanded area of the flexible display unit when additional expanding of the flexible display unit and a lack of a first touch input to the flexible display unit are sensed, and displaying the first image on the first area and the second area by enlarging the first image when the additional expanding of the flexible display unit and the first touch input are sensed.

16. The control method according to claim 15, further comprising the step of displaying the first image on the first area and the second area by gradually enlarging the first image according to the additional expanding of the flexible display unit.

17. The control method according to claim 15, wherein the second image is the image connected from the first image.

18. The control method according to claim 15, wherein the step of displaying the first image on the first area and the second area by enlarging the first image includes displaying the first image by enlarging the first image in all directions.

19. The control method according to claim 15, further comprising the step of displaying the first image by partially enlarging the first image on a basis of a point where the first touch input is sensed when the additional expanding of the flexible display unit, the first touch input, and a second touch input to the main display unit are sensed at the same time.

20. The control method according to claim 15, further comprising the step of switching the enlarged first image displayed on the first area and the second area to the first image on the first area and to the second image on the second area when release of the sensed first touch input is sensed.

21. The control method according to claim 15, further comprising the step of displaying a graphic user interface indicating an displayed area of the enlarged first image in the flexible display unit or the main display unit when the enlarged first image is displayed on the first area and the second area.

22. A control method of a portable device having a flexible display, the method comprising the steps of:
expanding a flexible display unit;
displaying a first image on a first area which is an expanded area of the flexible display unit; and
displaying a second image on a second area which is an expanded area of a retracted flexible display unit when retracting of the flexible display unit and a lack of a first touch input to the flexible display unit are sensed, and displaying the first image on the second area by downsizing the first image when the retracting of the flexible display unit and the first touch input are sensed.

23. The control method according to claim 22, wherein the step of displaying the first image on the second area by downsizing the first image includes a step of displaying the first image on the second area by gradually downsizing the first image according to the retracting of the flexible display unit.

24. The control method according to claim 22, wherein the first image includes the second image.

25. The control method according to claim 22, further comprising the step of displaying the first image by partially downsizing the first image on a basis of a point where the first touch input is sensed when the retracting of the flexible display unit, the first touch input, and a second touch input to the main display unit are sensed at the same time.

26. The control method according to claim 22, wherein the step of displaying the first image on the second area by downsizing the first image includes a step of displaying the first image on the second area by downsizing the first image in all directions.
